(19) United States
(12) Patent Application Publication
(10) Pub. No.: US 2022/0092544 A1
(43) Pub. Date: Mar. 24, 2022

(54) COLLABORATION SPACE IDENTIFICATION USING SENSORY ALIGNMENT

(71) Applicant: International Business Machines Corporation, Armonk, NY (US)

(72) Inventors: Amy Travis, Arlington, MA (US); Rogelio Vazquez-Rivera, Acton, MA (US); Liam S. Harpur, Dublin (IE); Jonathan D. Dunne, Dungarvan (IE)

(21) Appl. No.: 17/026,683

(22) Filed: Sep. 21, 2020

(51) Int. Cl. G06Q 10/10; G06Q 10/06; G06N 3/08; G06N 7/00

(52) U.S. Cl. CPC G06Q 10/103; G06N 7/005; G06N 3/08; G06Q 10/06314

(57) ABSTRACT

In an approach for collaboration space identification using sensory alignment, a processor collects scheduling information and expected device usage from historical log files for a forthcoming time period for a business. A processor determines historical and expected energy consumption from the scheduling information and expected device usage for the forthcoming time period. A processor determines an expected power usage based on the historical and expected energy consumption for the forthcoming time period. A processor monitors net incoming electricity to compare against the expected power usage for the forthcoming time period. A processor determines a level of significance between each location of the business and each application expected to be used in the forthcoming time period. A processor builds a model based on each level of significance determined that determines a probability of whether a respective location is optimal for collaboration.

### BACKGROUND

The present invention relates generally to the field of collaboration spaces, and more particularly to collaboration space identification using sensory alignment.

Collaboration is a working practice whereby individuals work together to a common purpose to achieve business benefit. Collaboration enables individuals to work together to achieve a defined and common business purpose. It exists in two forms: (1) synchronous, where everyone interacts in real time, as in online meetings, through instant messaging, or via video conferencing, and (2) asynchronous, where the interaction can be time-shifted, as when uploading documents or annotations to shared workspaces, or making contributions to a wiki.

Shared workspaces are among the most visible entries in the collaboration space. Aimed at rolling document and application sharing up with chat and perhaps versioning and other auditing capabilities, they may have more or fewer features, and may be available either for license or on a syndicated basis “in the cloud”.

### SUMMARY

Aspects of an embodiment of the present invention disclose a method, computer program product, and computer system for collaboration space identification using sensory alignment. A processor collects scheduling information and expected device usage from historical log files for a forthcoming time period for a business. A processor determines historical and expected energy consumption from the scheduling information and expected device usage for the forthcoming time period. A processor determines an expected power usage based on the historical and expected energy consumption for the forthcoming time period. A processor monitors net incoming electricity to compare against the expected power usage for the forthcoming time period. A processor determines a level of significance between each location of the business and each application expected to be used in the forthcoming time period. A processor builds a model based on each level of significance determined that determines a probability of whether a respective location is optimal for collaboration.

In some aspects of an embodiment of the present invention, a processor determines a level of significance between each location of the business and each application expected to be used in the forthcoming time period by conducting an exact test between each location and each application, wherein the exact test is selected from the group consisting of Fisher's exact test and Bernard's exact test.

In some aspects of an embodiment of the present invention, a processor builds the model based on each level of significance determined that determines the probability of whether a respective location is optimal for collaboration by running each level of significance determined through a neural network and training the model on data output by the neural network.

In some aspects of an embodiment of the present invention, a processor generalizes the model as more additional scheduling information and expected device usage is collected for additional forthcoming time periods.

In some aspects of an embodiment of the present invention, a processor alerts a user of a potential issue with energy usage for activities in the forthcoming time period based on the model.

In some aspects of an embodiment of the present invention, a processor collects the scheduling information and expected device usage from historical log files at an office-level of the business.

In some aspects of an embodiment of the present invention, a processor collects the scheduling information and expected device usage from historical log files for a forthcoming time period for a business by monitoring devices and applications expected to be used during the forthcoming time period under load and normal load conditions.

### BRIEF DESCRIPTION OF THE DRAWINGS

FIG. 1 depicts a block diagram of a distributed data processing environment, in accordance with an embodiment of the present invention.

FIG. 2 depicts a flowchart of the steps of a collaboration program, for collaboration space identification using sensory alignment, in accordance with an embodiment of the present invention.

FIG. 3 depicts a sample implementation output of the collaboration program, in accordance with an embodiment of the present invention.

FIG. 4 depicts a block diagram of a computing device of the distributed data processing environment, in accordance with an embodiment of the present invention.

### DETAILED DESCRIPTION

Embodiments of the present invention recognize that there are many scenarios where knowing or understanding a collaboration space is important. For example, malevolent actors could impersonate users with a resulting risk of data theft, said actors could even be computer bots. Also, when using collaboration channels in particular physical spaces, users want to know when the best time to collaborate is. Embodiments of the present invention recognize the need to mitigate these issues and that there is a need for an improvement to collaboration in general.

Additionally, embodiments of the present invention recognize the extensive use of electricity-powered devices to communicate and the wide variety of software applications that have a varied impact on electricity. Currently, much of the estimates of electricity usage are based on the current consumption rate, so the problem is how to best ascertain and use that electrical behavior to improve collaboration. For example, a demonstration of a graphics program at a meeting may require increased energy consumption during the meeting, while answering questions in a forum might require much less energy consumption as it may use just text-based applications and network usage. Embodiment of the present invention recognize that it would be useful to leverage the average electrical characteristics and historical data to ascertain if there is a correlation by space and user.

Embodiments of the present invention provide a system and method for collaboration space identification using sensory alignment. Embodiments of the present invention target historical and current rated/estimated energy usage in a space for applications, processes, and/or devices, so that unwanted activity can be ascertained and mitigated, and collaboration space can be identified. Embodiments of the present invention utilize a significance model to determine whether a location is an effective collaboration space for a user. For example, the system could estimate that between 1.8 and 3.5 KWh/m² of electricity was used in a certain space, which may be statistically significant for collaboration effectiveness. Embodiments of the present invention allow collaborating users to ascertain beforehand what the electrical characteristics of each user such that any unexpected electricity-usage behavior is made aware to the users. Embodiments of the present invention keep statistics of the actual crowdsourced usage and use historical data to do a predictive analysis of future usage to better allow user to manage collaboration effectiveness.

Embodiments of the present invention provide a system and method that gathers application usage data, space usage data, and electricity consumption data; uses the gathered data to derive an electricity usage significance (EUSA) model; and uses the EUSA model to determine significant electricity-usage environments. Embodiments of the present invention can generalize the EUSA model so that the EUSA model can be used as a template on a per domain/organization basis.

The present invention may contain various accessible data sources, such as server 110 and user computing device 120, that may include personal data, content, or information the user wishes not to be processed. Personal data includes personally identifying information or sensitive personal information as well as user information, such as height, weight etc. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Collaboration program 112 enables the authorized and secure processing of personal data. Collaboration program 112 provides informed consent, with notice of the collection of personal data, allowing the user to opt in or opt out of processing personal data.

Consent by a user can take several forms. Opt-in consent can impose on the user to take an affirmative action before personal data is processed. Alternatively, opt-out consent can impose on the user to take an affirmative action to prevent the processing of personal data before personal data is processed. Collaboration program 112 provides information regarding personal data and the nature (e.g., type, scope, purpose, duration, etc.) of the processing. Collaboration program 112 provides the user with copies of stored personal data. Collaboration program 112 allows the correction or completion of incorrect or incomplete personal data. Collaboration program 112 allows the immediate deletion of personal data.

The present invention will now be described in detail with reference to the Figures.

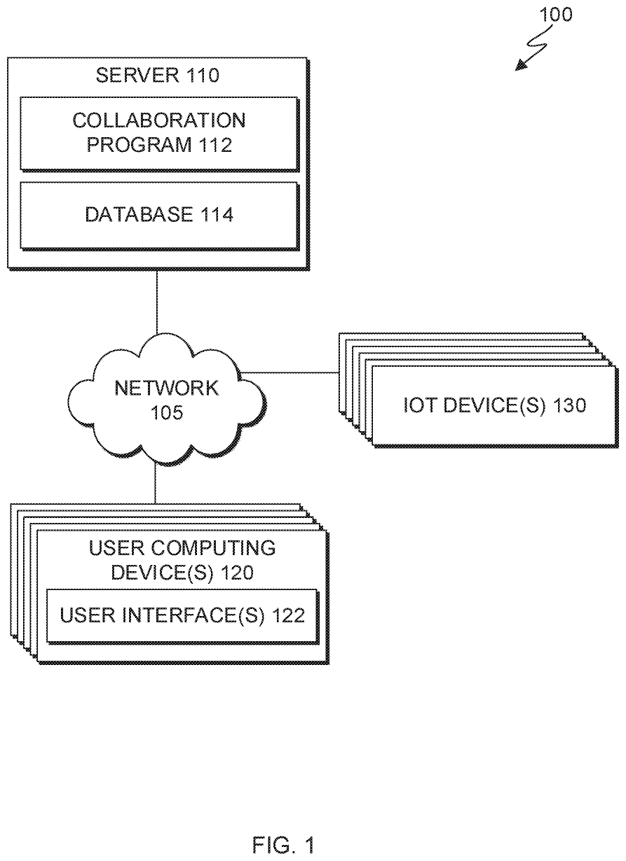

FIG. 1 depicts a functional block diagram illustrating distributed data processing environment 100, in accordance with an embodiment of the present invention. The term “distributed” as used herein describes a computer system that includes multiple, physically distinct devices that operate together as a single computer system. FIG. 1 provides only an illustration of one embodiment of the present invention and does not imply any limitations with regard to the environments in which different embodiments may be implemented. Many modifications to the depicted environment may be made by those skilled in the art without departing from the scope of the invention as recited by the claims.

In the depicted embodiment, distributed data processing environment 100 includes server 110, user computing device(s) 120, and IoT device(s) 130 interconnected over network 105. In an embodiment, distributed data processing environment 100 represents a system that constructs machine learning models for recommending products to a user. Network 105 can be, for example, a local area network (LAN), a wide area network (WAN) such as the Internet, or a combination of the two, and can include wired, wireless, or fiber optic connections. Network 105 can include one or more wired and/or wireless networks that are capable of receiving and transmitting data, voice, and/or video signals, including multimedia signals that include voice, data, and video information. In general, network 105 can be any combination of connections and protocols that will support communications between server 110, user computing device(s) 120, and IoT device(s) 130. Distributed data processing environment 100 may include additional servers, computers, or other devices not shown.

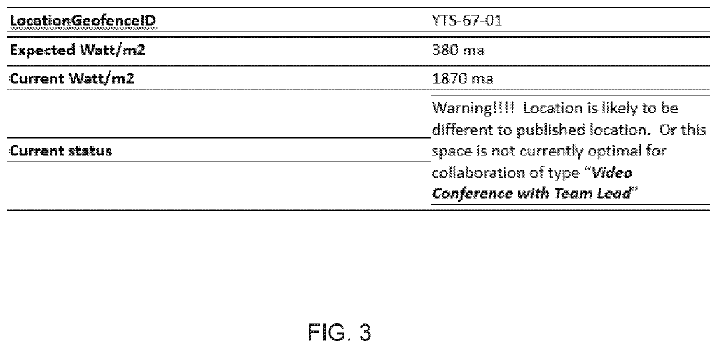

Server 110 operates to run collaboration program 112. In the depicted embodiment, server 110 contains collaboration program 112. In some embodiments, server 110 can be a standalone computing device, a management server, a web server, or any other electronic device or computing system capable of receiving, sending, and processing data and capable of communicating with user computing device(s) 120 and IoT device(s) 130 via network 105. In other embodiments, server 110 represents a server computing system utilizing multiple computers as a server system, such as a cloud computing environment. In yet other embodiments, server 110 represents a computing system utilizing clustered computers and components (e.g., database server computers, application server computers, etc.) that act as a single pool of seamless resources when accessed within distributed data processing environment 100. Server 110 may include components as described in further detail in FIG. 3.

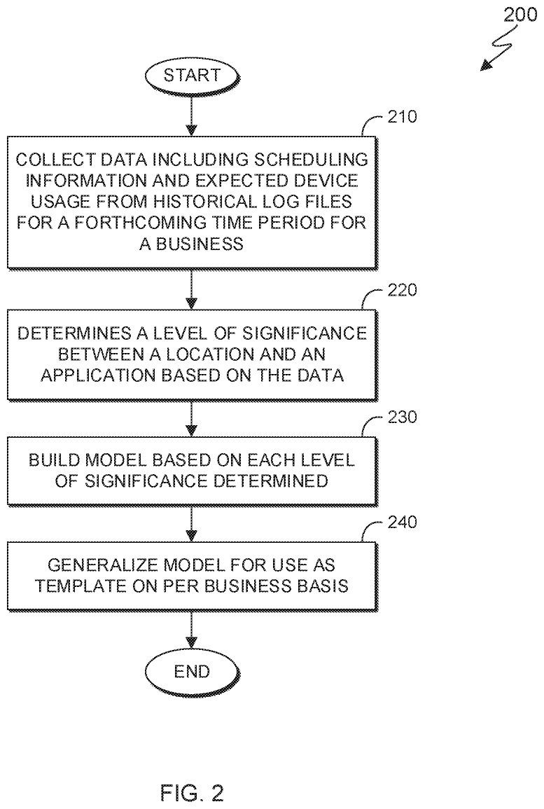

Collaboration program 112 operates to identify collaboration space using sensory alignment. In the depicted embodiment, collaboration program 112 resides on server 110 with user interface(s) 122 being a local app interface of collaboration program 112 running on respective user computing device(s) 120. In other embodiments, collaboration program 112 may be run locally on user computing device(s) 120 or on another device (not shown) provided that collaboration program 112 has access to network 105. In yet other embodiments, certain steps of collaboration program 112 can be run on server 110 and other steps collaboration program 112 can be run on user computing device(s) 120 through respective user interface(s) 122 provided that collaboration program 112 has access to network 105 to exchange information between server 110, user computing device(s) 120, and IoT device(s) 130. Collaboration program 112 is described in more detail below with reference to FIG. 2.

Database 114 operates as a repository for data received, used, and/or output by collaboration program 112. Data received, used, and/or generated may include, but is not limited to, IoT data from IoT device(s) 130; scheduling information, i.e., expected application usage or activity by user, and device usage, for a forthcoming time period; and any other data received, used, and/or output by collaboration program 112. Database 114 can be implemented with any type of storage device capable of storing data and configuration files that can be accessed and utilized by server 110, user computing device(s) 120, and/or IoT device(s) 130, such as a hard disk drive, a database server, or a flash memory. In an embodiment, database 114 is accessed by collaboration program 112, user computing device(s) 120, and/or IoT device(s) 130 to store and/or to access the data. In another embodiment, database 114 may reside on another computing device, server, cloud server, or spread across multiple devices elsewhere (not shown) within distributed data processing environment 100, provided that database 114 has access to network 105.

User computing device(s) 120 operate as a user computing device that can send and receive data. In some embodiments, user computing device(s) 120 may be, but are not limited to, an electronic device, such as a laptop computer, a tablet computer, a netbook computer, a personal computer (PC), a desktop computer, a smart phone, a wearable computing device, or any programmable electronic device capable of running respective user interface(s) 122 and communicating (i.e., sending and receiving data) with server 110, IoT device(s) 130 and/or collaboration program 112 via network 105. In some embodiments, user computing device(s) 120 represent one or more programmable electronic devices or combination of programmable electronic devices capable of executing machine readable program instructions and communicating with server 110, IoT device(s) 130, and/or other computing devices within distributed data processing environment 100 via a network, such as network 105. In an embodiment, user computing device(s) 120 represent one or more devices associated with one or more users. In the depicted embodiment, user computing device(s) 120 include respective user interface(s) 122. User computing device(s) 120 may include components as described in further detail in FIG. 3.

User interface(s) 122 operate as local user interfaces on respective user computing device(s) 120 through which one or more users of user computing device(s) 120 interact with user computing device(s) 120. In some embodiments, user interface(s) 122 are a local app interface of collaboration program 112 on user computing device(s) 120. In some embodiments, user interface(s) 122 are a graphical user interface (GUI), a web user interface (WUI), and/or a voice user interface (VUI) that can display (i.e., visually), present (i.e., audibly), and/or enable a user to enter or receive information (i.e., graphics, text, and/or sound) for or from collaboration program 112 via network 105. In an embodiment, user interface(s) 122 enable a user to send and receive data (i.e., to and from collaboration program 112 via network 105, respectively). In an embodiment, user interface(s) 122 enable a user to receive alerts and view alerts from collaboration program 112.

IoT device(s) 130 operate as physical devices and/or everyday objects that are embedded with electronics, Internet connectivity, and other forms of hardware (i.e., sensors). In general, IoT devices can communicate and interact with other IoT devices over the Internet while being remotely monitored and controlled. In the depicted embodiment, IoT device(s) 130 are monitored and managed by collaboration program 112 on server 110 and/or one or more users through user interface(s) 122. Types of IoT devices include, but are not limited to, smart cameras, IoT sensors, smart locks, smart doors, smart refrigerators, smart watches, smart thermostats, smart coffee machines, smart washer/dryer units, smart TVs, mobile devices, laptop computing devices, computing tablets, virtual assistance devices, and any other smart business/corporate devices. IoT device(s) 130 may include components as described in further detail in FIG. 3.

FIG. 2 depicts a flowchart 200 of the steps of collaboration program 112, for identifying collaboration space using sensory alignment, in accordance with an embodiment of the present invention. In an embodiment, collaboration program 112 collects data, analyzes the data to determine a level of significance between a location and an application, builds a model using the analyzed data, and generalizes the model. It should be appreciated that the process depicted in FIG. 2 illustrates one possible iteration of collaboration program 112.

In step 210, collaboration program 112 collects data. In an embodiment, collaboration program 112 collects multiple types of data from a plurality of computing devices and systems for a business at an office-level, floor-level, or building-level. For example, collaboration program 112 collects data from user computing device(s) 120 and IoT device(s) 130 for a business in a building with ten floors at a floor-level.

Data includes, but is not limited to, building environmental data, scheduling information, i.e., expected application usage or activity (e.g., system events) and device usage, for a forthcoming time period. Data also includes historical log files to capture historical or expected energy consumption of the expected application and/or device usage depending on the scheduling information for the forthcoming time period. A log file is a file that contains a list of events, which have been “logged” by a computer. Log files are often generated during software installations and are created by Web servers, but they can be used for many other purposes as well. Most log files are saved in a plain text format, which minimizes their file size and allows them to be viewed in a basic text editor. Log files may also be generated by software utilities, File Transfer Protocol (FTP) programs, and operating systems.

In an embodiment, collaboration program 112 collects the scheduling information via an OS/application API on the plurality of computing devices or a business work queue. In an embodiment, collaboration program 112 collects the historical log files from crowd-sourced information and/or API on a user's computing device to capture previous usage by the user. In an embodiment, collaboration program 112 captures an energy consumption of the applications and/or devices by monitoring the device, application, and/or process under load and normal load over time, e.g., the forthcoming time period. In an embodiment, collaboration program 112 collects data associated with users' activity, i.e., particular users will have repeatable energy usage patterns for particular tasks or particular tasks undertaken with particular other users or types of users.

In an embodiment, based on the data collected associated with the historical power usage for the expected applications and/or devices, collaboration program 112 determines an expected power usage for the forthcoming time period. In an embodiment, collaboration program 112 monitors net incoming electricity to compare against the expected power usage for the forthcoming time period.

In step 220, collaboration program 112 determines a level of significance between a location and an application based on the data. In an embodiment, collaboration program 112 analyzes the data collected in the previous step to determine a level of significance of a location of a business or organization. In an embodiment, collaboration program 112 analyzes the data by arranging the data in a n*n contingency table and conduct an exact test, e.g., Fisher's or Bernard's exact test, to determine the level of significance between a location and an application. In an embodiment, collaboration program 112 creates a n*n contingency table and conducts an exact test for each location against each application to determine the level of significance between a location and an application. For example, Table 1 below depicts a 2*2 contingency table of Application X versus Design Studio.

TABLE 1
Exemplary 2*2 Contingency Table

| | Design Studio | All Other Locations |
|---|---|---|
| Application X (Watt/hour) | 26325 | 12894 |
| All Other Applications (Watt/hour) | 1129 | 100158 |

Continuing this example, collaboration program 112 uses Fisher's exact test on the data in Table 1 and receives a resulting p-value, i.e., probability of series of events being dependent or independent, of <2.2e⁻¹⁶ indicating that there is a very strong dependence, i.e., high level of significance, between the Design Studio and the Watt/hour usage of Application X versus all other applications.

In step 230, collaboration program 112 builds a model using the analyzed data. In an embodiment, collaboration program 112 builds a model using the analyzed data from the previous step. In an embodiment, collaboration program 112 builds a model by running the analyzed data through a neural network, in which the neural network will clip the analyzed data to remove extreme values, i.e., outliers, and perform a data transformation to reduce dispersion in the analyzed data. In general, neural networks comprise artificial neurons and connections that typically have a weight that adjusts as learning proceeds. The weight increases or decreases the strength of the signal at a connection. Typically, artificial neurons are organized in layers. Different layers may perform different kinds of transformations on their inputs. Signals travel from the first (input) layer to the last (output) layer, possibly after traversing the layers multiple times. In an embodiment, collaboration program 112 trains the model using the data output by the neural network to determine if a location is optimal for collaboration. In an embodiment, collaboration program 112 uses the model to compare and contrast what a location or user are likely to use in terms of energy to determine if a location is optimal for collaboration.

In an example embodiment, the following pseudo code can be used to implement collaboration program 112 to build a logistic regression model that determines a probability of whether a location is optimal for collaboration and then train input parameters (X1, X2, etc.) to predict the output parameter (Y):
Define model(data, X_train, Y_train, X_test, Y_test, num_iterations):
   initialize parameters with zeros
   Perform Gradient descent
   Predict test/train set examples
   Print train/test Errors
return result

In some embodiments, collaboration program 112 modifies a user's presence or collaboration status based on the model. In these embodiments, collaboration program 112 applies the model to determine whether a user's energy consumption is above or below an average energy consumption rate as determined using the model. If collaboration program 112 determines the user's energy consumption is below their average energy consumption rate, collaboration program 112 modifies the user's presence status to “idle” or “away”. If collaboration program 112 determines the user's energy consumption is above their average energy consumption rate, collaboration program 112 modifies the user's presence status to “busy”.

In some embodiments, collaboration program 112 alerts collaborating users of an electrical discrepancy that would denote a different or sub-optimal collaboration pattern based on the model. For example, based on the model, collaboration program 112 determines too much electricity is being used indicating user A is in a different location, is a different user, or is not in an optimal location for the intended collaboration. In this example, collaboration program 112 sends an alert to user A through user interface 122A of user computing device 122A. FIG. 3 depicts a sample implementation output by collaboration program 112, in accordance with an embodiment of the present invention.

In some embodiments, collaboration program 112 alerts a user as to potential issues with energy usage for activities in their upcoming schedule, i.e., the forthcoming time period described above during the collection of the scheduling data. For example, looking at the battery usage on a laptop when a user is traveling to a location that may not have power outlets or a location where energy availability is limited. In these embodiments, collaboration program 112 factors in who the user will be collaborating with when alerting the user as to potential issues with energy usage for activities in their upcoming schedule.

In step 240, collaboration program 112 generalizes the model. In an embodiment, collaboration program 112 generalizes the model for use as a template on a per business/organization basis, i.e., refines the model based on a wider range of observations. This can be done as more input data is collected and have a greater sense as to the spread of observations. The greater the spread of input data, the more general the predictions by the model can become. In an embodiment, collaboration program 112 uses prior activity of a user to pick an electricity usage profile for that user, in which the electricity usage profile is based on other users doing the same type of task as the user. In an embodiment, collaboration program 112 aggregates users into user cohorts based on the type of activity, applications, and/or devices used by the users.

In an example embodiment, the following pseudo code can be used to implement collaboration program 112 to generalize the model using the logistic regression model by defining the variables, using a sigmoid function as a predictor function, and converting the probabilities to actual predictions:
def prediction_function(w, b, X):
   Predict whether the data reach needs change (1) or not (0) using learned logistic regression parameters (w, b)
Compute predicted the log level change
   Determine current level vs optimal level
   currentDRLevel=lookupDRLevel(productName);
   optimumDRLevel=DREvent.getDRLevel( );
   if currentDRLevel<optimumDRLevel:
   deamon.changeDRLevel(productName, DREvent.getDRLevel( );
   else:
   #Determine if a given duration is passed
      if deamon.durationPassed(productName, DREvent.getDuration( )):
      deamon.restoreDRLevel(productName)

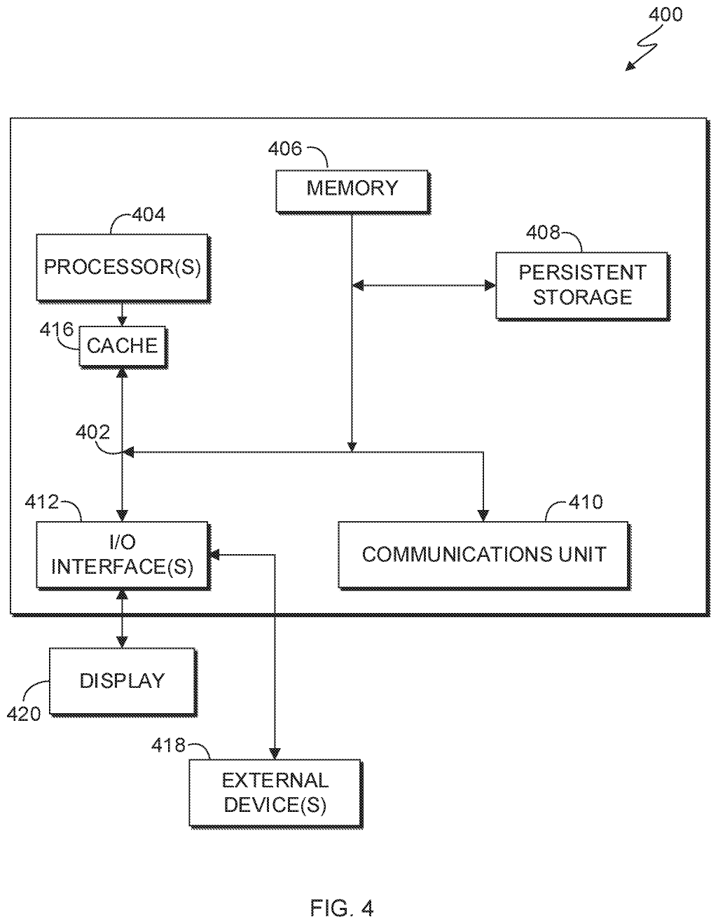

FIG. 4 depicts a block diagram of components of computing device 400 suitable for server 110, user computing device(s) 120, and/or IoT device(s) 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Programs may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Programs may be downloaded to persistent storage 408 through communications unit 410.

I/O interface(s) 412 allows for input and output of data with other devices that may be connected to server 110, user computing device(s) 120, and/or IoT device(s) 130. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
collecting, by one or more processors, scheduling information and expected device usage from historical log files for a forthcoming time period for a business;
determining, by the one or more processors, historical and expected energy consumption from the scheduling information and expected device usage for the forthcoming time period;
determining, by the one or more processors, an expected power usage based on the historical and expected energy consumption for the forthcoming time period;
monitoring, by the one or more processors, net incoming electricity to compare against the expected power usage for the forthcoming time period;
determining, by the one or more processors, a level of significance between each location of the business and each application expected to be used in the forthcoming time period; and
building, by the one or more processors, a model based on each level of significance determined that determines a probability of whether a respective location is optimal for collaboration.

2. The computer-implemented method of claim 1, wherein determining the level of significance between each location of the business and each application expected to be used in the forthcoming time period comprises:
conducting, by the one or more processors, an exact test between each location and each application, wherein the exact test is selected from the group consisting of Fisher's exact test and Bernard's exact test.

3. The computer-implemented method of claim 1, wherein building the model based on each level of significance determined that determines the probability of whether a respective location is optimal for collaboration comprises:
running, by the one or more processors, each level of significance determined through a neural network; and
training, by the one or more processors, the model on data output by the neural network.

4. The computer-implemented method of claim 1, further comprising:
generalizing, by the one or more processors, the model as more additional scheduling information and additional expected device usage is collected for additional forthcoming time periods.

5. The computer-implemented method of claim 1, further comprising:
alerting, by the one or more processors, a user of a potential issue with energy usage for activities in the forthcoming time period based on the model.

6. The computer-implemented method of claim 1, wherein collecting the scheduling information and the expected device usage from the historical log files for the forthcoming time period for the business further comprises:
wherein the collecting is done at an office-level of the business.

7. The computer-implemented method of claim 1, wherein collecting the scheduling information and the expected device usage from the historical log files for the forthcoming time period for the business comprises:
monitoring, by the one or more processors, devices and applications expected to be used during the forthcoming time period under load and normal load conditions.

8. A computer program product comprising:
one or more computer readable storage media and program instructions stored on the one or more computer readable storage media, the program instructions comprising:
program instructions to collect scheduling information and expected device usage from historical log files for a forthcoming time period for a business;
program instructions to determine historical and expected energy consumption from the scheduling information and expected device usage for the forthcoming time period;
program instructions to determine an expected power usage based on the historical and expected energy consumption for the forthcoming time period;
program instructions to monitor net incoming electricity to compare against the expected power usage for the forthcoming time period;
program instructions to determine a level of significance between each location of the business and each application expected to be used in the forthcoming time period; and
program instructions to build a model based on each level of significance determined that determines a probability of whether a respective location is optimal for collaboration.

9. The computer program product of claim 8, wherein the program instructions to determine the level of significance between each location of the business and each application expected to be used in the forthcoming time period comprise:
program instructions to conduct an exact test between each location and each application, wherein the exact test is selected from the group consisting of Fisher's exact test and Bernard's exact test.

10. The computer program product of claim 8, wherein the program instructions to build the model based on each level of significance determined that determines the probability of whether a respective location is optimal for collaboration comprise:
program instructions to run each level of significance determined through a neural network; and
program instructions to train the model on data output by the neural network.

11. The computer program product of claim 8, further comprising:
program instructions to generalize the model as more additional scheduling information and additional expected device usage is collected for additional forthcoming time periods.

12. The computer program product of claim 8, further comprising:
program instructions to alert a user of a potential issue with energy usage for activities in the forthcoming time period based on the model.

13. The computer program product of claim 8, wherein the program instructions to collect the scheduling information and the expected device usage from the historical log files for the forthcoming time period for the business further comprise:
wherein the collecting is done at an office-level of the business.

14. The computer program product of claim 8, wherein the program instructions to collect the scheduling information and the expected device usage from the historical log files for the forthcoming time period for the business comprise:
program instructions to monitor devices and applications expected to be used during the forthcoming time period under load and normal load conditions.

15. A computer system comprising:
one or more computer processors;
one or more computer readable storage media;
program instructions stored on the computer readable storage media for execution by at least one of the one or more processors, the program instructions comprising:
program instructions to collect scheduling information and expected device usage from historical log files for a forthcoming time period for a business;
program instructions to determine historical and expected energy consumption from the scheduling information and expected device usage for the forthcoming time period;
program instructions to determine an expected power usage based on the historical and expected energy consumption for the forthcoming time period;
program instructions to monitor net incoming electricity to compare against the expected power usage for the forthcoming time period;
program instructions to determine a level of significance between each location of the business and each application expected to be used in the forthcoming time period; and
program instructions to build a model based on each level of significance determined that determines a probability of whether a respective location is optimal for collaboration.

16. The computer system of claim 15, wherein the program instructions to determine the level of significance between each location of the business and each application expected to be used in the forthcoming time period comprise:
program instructions to conduct an exact test between each location and each application, wherein the exact test is selected from the group consisting of Fisher's exact test and Bernard's exact test.

17. The computer system of claim 15, wherein the program instructions to build the model based on each level of significance determined that determines the probability of whether a respective location is optimal for collaboration comprise:
program instructions to run each level of significance determined through a neural network; and
program instructions to train the model on data output by the neural network.

18. The computer system of claim 15, further comprising:
program instructions to generalize the model as more additional scheduling information and additional expected device usage is collected for additional forthcoming time periods.

19. The computer system of claim 15, further comprising:
program instructions to alert a user of a potential issue with energy usage for activities in the forthcoming time period based on the model.

20. The computer system of claim 15, wherein the program instructions to collect the scheduling information and the expected device usage from the historical log files for the forthcoming time period for the business further comprise:
wherein the collecting is done at an office-level of the business.
